(19) United States
(12) Patent Application Publication
(10) Pub. No.: US 2012/0117030 A1
(43) Pub. Date: May 10, 2012

(54) DATABASE MIGRATION MANAGEMENT APPARATUS AND METHOD THEREOF

(76) Inventor: AYAKO SAKUMA, Tokyo (JP)

(21) Appl. No.: 13/240,552

(22) Filed: Sep. 22, 2011

(30) Foreign Application Priority Data
Nov. 9, 2010 (JP) 2010-250910

(51) Int. Cl. G06F 7/00

(52) U.S. Cl. 707/654; 707/E17.005; 707/E17.045

(57) ABSTRACT

A database migration management apparatus includes: a data storage destination decision unit for deciding to place target data in a first database and a second database when there exists an access pattern; and a migration schedule decision unit for, when the data storage destination decision unit places the target data in the first database and the second database: distinguishing a period during which the number of write access is equal to or more than a specified number to decide a migration schedule such that the target data obtained over a period corresponding to the distinguished period is placed in the first database; and distinguishing a period during which the number of read access is equal to or more than a specified number to decide a migration schedule such that the target data obtained over a period corresponding to the distinguished period is placed in the second database.

This application is based upon and claims the benefit of priority from Japanese patent application No. 2010-250910, filed on Nov. 9, 2010, the disclosure of which is incorporated herein in its entirety by reference.

### BACKGROUND

The present invention relates to a database migration management apparatus and a method thereof.

A management apparatus that automatically searches heterogeneous databases and efficiently exchanges access target data between complicated networks are widely known.

As such a management apparatus, for example, a heterogeneous database integration management system apparatus is disclosed in Patent Publication JP-A-11-025106. In the heterogeneous database integration management system apparatus in Patent Publication JP-A-11-025106, when a keyword related to data to be searched for is input, heterogeneous databases distributed on networks are searched for data related to the keyword to integrate data extracted by a data extraction unit, based on: related information between heterogeneous databases that store data related to the keyword input by keyword input means; and a data-related definition file that defines interfaces with the heterogeneous databases.

In recent years, a technology for providing a relational database (RDB) and a key-value store (KVS) with a common interface as a relational database management system (RDBMS) for the cloud is rapidly rising.

Among databases, a relational database most widely used at present includes a strict transaction function, and can execute a highly efficient updating process and read process. Therefore, the use of a relational database is suitable for a business application necessary to guarantee consistency and integrity in access target data. However, on the other hand, there are problems that when a large number of access and a large amount of access target data are handled with a relational database, a hardware (HW) cost increases, and the scalability is low due to the structure of a relational database.

In contrast, the hardware cost of a key-value store is low, and the scalability is easy to be enhanced. Consequently, it is expected in recent years that the use as a database in a cloud environment increases. However, when access target data are scalably distributed, there is a problem that it takes enormous amounts of time to realize an exclusion process on update equal to that of a relational database.

In a service providing form to charge at a data center and the like depending on the usage time and a device used, reduction in hardware-related costs by increasing the efficiency of use of hardware is an issue for cloud service providers, and reduction in service use-related costs is an issue for service users.

Conventionally, after a database model is decided upon the construction of a system, the database model is not changed. Accordingly, a relational database is adopted even for a business application where updating processes that require a strict transaction function concentrate on a fixed time period, and expensive hardware continues to be operated even over a time period during which there are a few updating processes. As a result, the costs are wasted.

When a key-value store is used, hardware resource is necessary more than when a relational database is used; however, it becomes possible to use inexpensive hardware. Hence, there is a problem that conventional usage in which access target data unnecessary to use a relational database are stored in a relational database becomes a detriment to service providers who intend to make effective use of hardware resource and service users who intend to reduce usage charges.

### SUMMARY

An exemplary object of the present invention is to provide a database migration management apparatus and a method thereof, which can improve the convenience of both providers and users.

A database migration management apparatus according to one aspect of the present invention includes: an access collection unit for collecting write access and read access transmitted from a specified server, and storing the numbers of access to a first database having low scalability and a second database having high scalability for each piece of information on access target data and each type of access in a storage unit at specified time intervals; an access analysis unit for determining whether there exists a specified pattern in the numbers of access at the specified time intervals collected by the access collection unit, and storing the numbers of access at the specified time intervals in the storage unit as an access pattern when there exists the pattern; a data storage destination decision unit for deciding to place the access target data in the first database and the second database when there exists the access pattern analyzed by the access analysis unit; and a migration schedule decision unit for, when the data storage destination decision unit places the access target data in the first database and the second database, distinguishing a period during which the number of the write access is equal to or more than a specified number, and deciding a migration schedule such that the access target data obtained over a period corresponding to the distinguished period is placed in the first database, as well as distinguishing a period during which the number of the read access is equal to or more than a specified number, and deciding a migration schedule such that the access target data obtained over a period corresponding to the distinguished period is placed in the second database.

### DESCRIPTION OF THE DRAWINGS

FIG. 1 is an example of a block diagram showing a configuration of a database migration management system of an exemplary embodiment;

FIG. 2 is an example of a block diagram showing a hardware configuration of the database migration management apparatus;

FIG. 3 is an example of a block diagram showing a functional configuration of the database migration management apparatus;

FIG. 4 is an example of a flowchart showing an entire flow of the database migration management apparatus;

FIG. 5 is an example of a flowchart showing a data structure analysis processing procedure;

FIG. 6 is an example of a flowchart showing an access analysis processing procedure;

FIG. 7 is an example of a conceptual diagram provided for an explanation of a database access pattern;

FIG. 8 is an example of a flowchart showing a data storage destination decision processing procedure;

FIG. 9 is an example of a flowchart showing a database migration processing procedure; and

FIG. 10 is an example of a flowchart showing a database migration processing procedure.

### EXEMPLARY EMBODIMENT

A detailed description will hereinafter be given of an exemplary embodiment of the present invention with reference to drawings.

### ==Configuration==

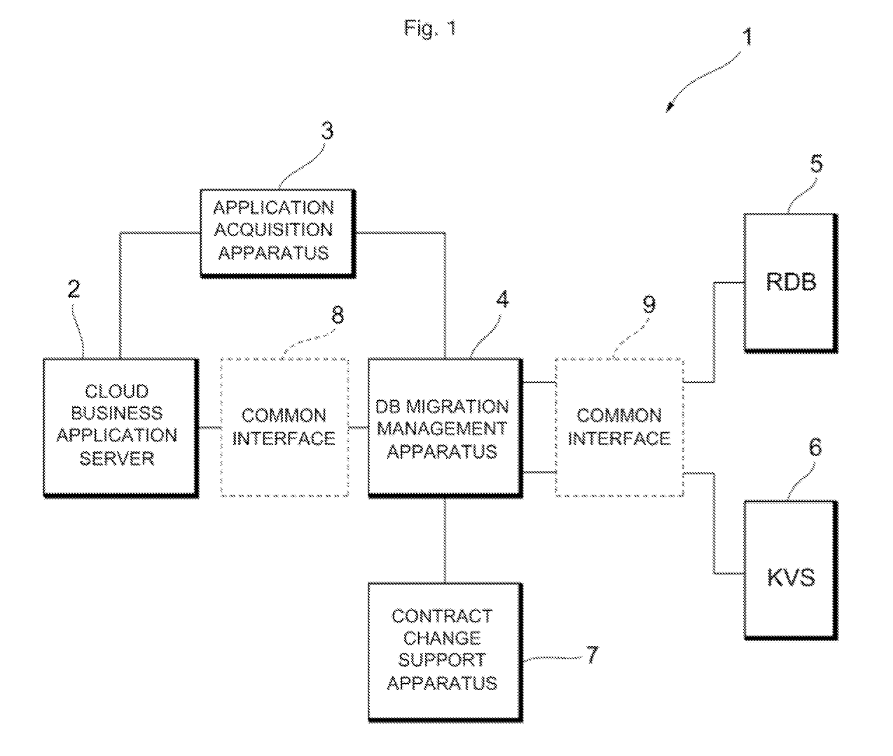

FIG. 1 is a view illustrating a configuration of a database (DB) migration management system 1 of the embodiment. The database migration management system 1 is configured to include a cloud business application server 2, an application acquisition apparatus 3, a database (DB) migration management apparatus 4, a relational database (RDB) 5, a key-value store (KVS) 6, and a contract change support apparatus 7.

The DB migration management apparatus 4 is installed between the cloud business application server 2, the RDB 5, and the KVS 6.

Specifically, the cloud business application server 2 is connected to the application acquisition apparatus 3. Furthermore, the cloud business application server 2 is connected to the DB migration management apparatus 4 via an existing common interface 8. The application acquisition apparatus 3 is connected to the DB migration management apparatus 4. The DB migration management apparatus 4 is connected to the RDB 5 and the KVS 6 via an existing common interface 9. In addition, the DB migration management apparatus 4 is connected to the contract change support apparatus 7.

The cloud business application server 2 is configured to have the same hardware (unillustrated) as a normal computer apparatus such as a Central Processing Unit (CPU), a Read Only Memory (ROM) connected to the CPU on a bus, a Random Access Memory (RAM), a storage unit, an input unit, a display unit, and an input/output interface. The cloud business application server 2 executes various cloud business applications.

The application acquisition apparatus 3 is configured to have the same hardware (unillustrated) as a normal computer apparatus such as a CPU, a ROM connected to the CPU on a bus, a RAM, a storage unit, an input unit, a display unit, and an input/output interface. The application acquisition apparatus 3 transmits to the DB migration management apparatus 4 a cloud business application program stored in the cloud business application server 2.

The DB migration management apparatus 4 for a fixed time period stores a data structure in which a cloud business application is analyzed and access patterns of read access and write access, and manages the migration of access target data between the RDB 5 and the KVS 6 based on a difference in access patterns of read access and write access over a specific time period, for example, on a per-day or per-day of week basis. A description will later be given of the hardware and functional configurations of the DB migration management apparatus 4.

The RDB 5 and the KVS 6 create a database related to access target data used for various cloud business applications and stores information on the access target data and relations thereof.

The contract change support apparatus 7 presents a user of a cloud business application with the contents of a contract including usage charges of when the operation form is changed based on a difference between read access and write access over a fixed time period, for example, on a per-day or per-day of week basis, and, when the operation form is changed, notifies the DB migration management apparatus 4 to that effect.

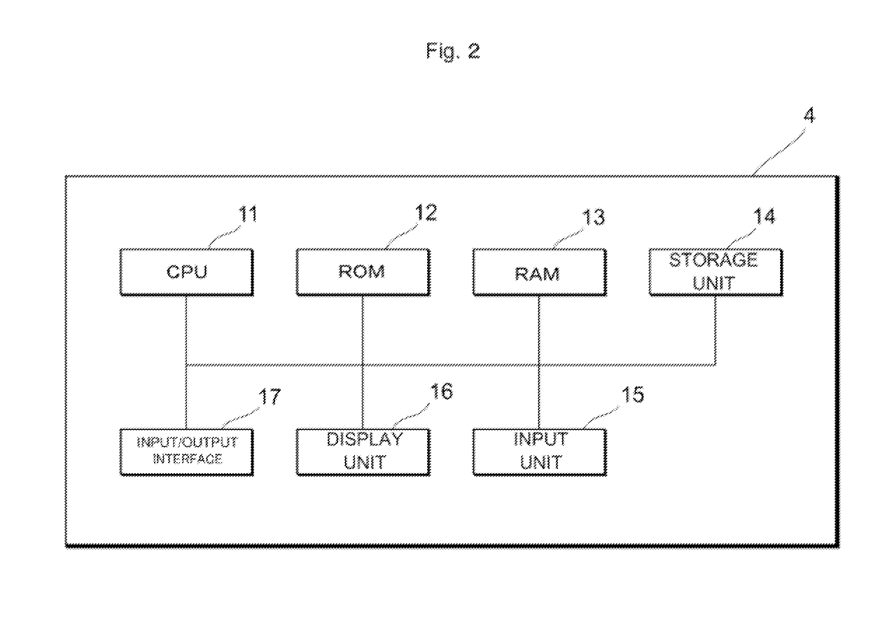

FIG. 2 is a view illustrating a hardware configuration of the DB migration management apparatus 4. The DB migration management apparatus 4 has the same hardware (unillustrated) as a normal computer apparatus such as a CPU 11, a ROM 12 connected to the CPU 11 on a bus, a RAM 13, a storage unit 14, an input unit 15, a display unit 16, and an input/output interface 17. Here, the storage unit 14 is, for example, an external storage device such as a Hard Disk Drive (HDD).

Physically speaking, the DB migration management apparatus 4 may be any one of a specialized system and a general-purpose information processor. In an information processing device with a general configuration, for example, each process in the DB migration management apparatus 4 can be realized by invoking an application program that includes codes for each process.

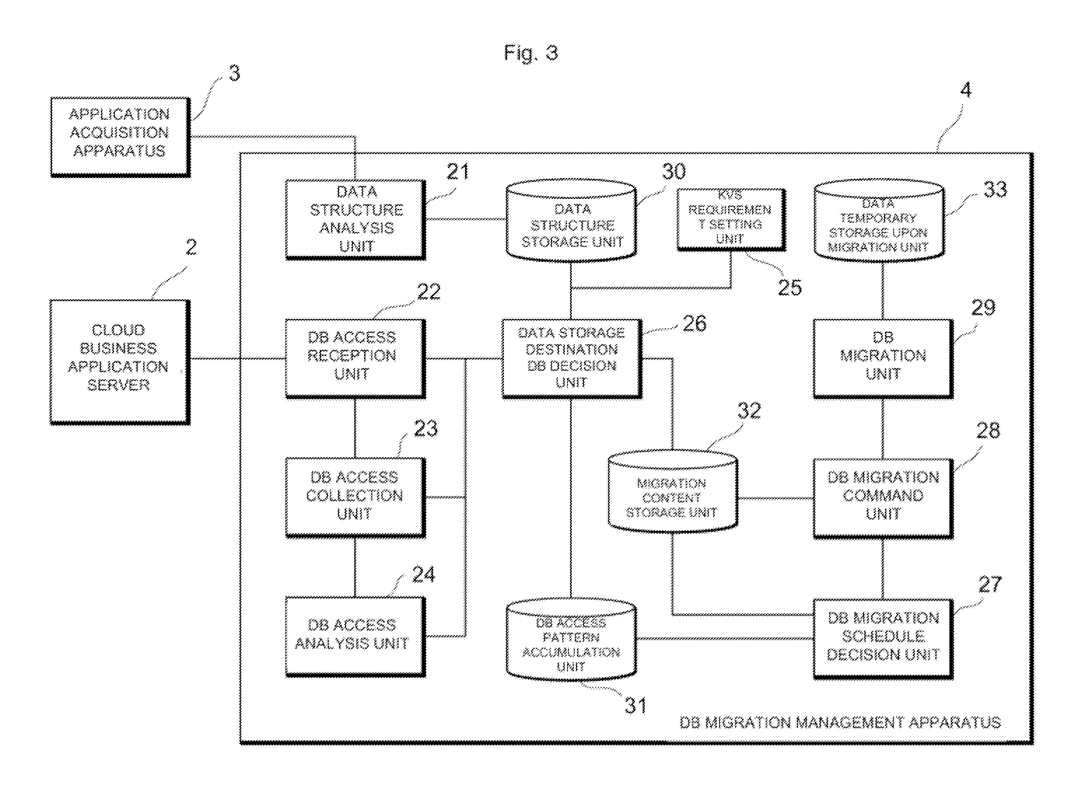

FIG. 3 is a view illustrating a functional configuration of the DB migration management apparatus 4. The DB migration management apparatus 4 functionally has at least a data structure analysis unit 21, a database (DB) access reception unit 22, a database (DB) access collection unit 23, a database (DB) access analysis unit 24, a KVS requirement setting unit 25, a data storage destination database (DB) decision unit 26, a database (DB) migration schedule decision unit 27, a database (DB) migration command unit 28, and a database (DB) migration unit 29. The data structure analysis unit 21 to the DB migration unit 29 can be realized by mainly causing the CPU 11 to invoke programs stored in the ROM 12 and the RAM 13 to control hardware.

Furthermore, the DB migration management apparatus 4 functionally has a data structure storage unit 30, a database (DB) access pattern accumulation unit 31, a migration content storage unit 32, and a data temporary storage upon migration unit 33. The data structure storage unit 30 to the data temporary storage upon migration unit 33 are configured by using the RAM 13 and the storage unit 14, for example.

The data structure analysis unit 21 analyzes a cloud business application program received from the application acquisition apparatus 3, and stores data structure information such as information on relations between data, which is the analysis result, in the data structure storage unit 30.

The DB access reception unit 22 receives write access and read access to access target data from the cloud business application server 2, and transmits to the DB access collection unit 23 write access and read access related to the data structure information stored in the data structure storage unit 30.

The DB access collection unit 23 groups the write access and read access received from the DB access reception unit 22 according to information on the access target data, a type of access (read or write), and the like. Moreover, the DB access collection unit 23 counts the number of access per second according to the grouped information on access target data and type of access, and every second accumulates in the DB access pattern accumulation unit 31 the number of access per second according to the counted information on access target data and type of access (hereinafter referred to simply as the number of access) as well as the write access and read access.

The DB access analysis unit 24 arranges the numbers of access acquired from the access pattern accumulation unit 31 on the time series and graphs them to carry out pattern analysis. The DB access analysis unit 24 then creates a database (DB) access pattern 41 (described later) to accumulate the pattern in the DB access pattern accumulation unit 31. Moreover, the DB access analysis unit 24 starts pattern analysis on a per-hour basis after a specified time passes since the start of access collection, and carries out pattern analysis on per-day, per-day of week, and per-month bases and pattern analysis for a specific time period after a specified day, week, and month pass. The DB access analysis unit 24 then creates the DB access pattern 41 (described later). Incidentally, the DB access analysis unit 24 does not carry out pattern analysis on write access and read access to the access target data placed in the KVS 6.

The KVS requirement setting unit 25 sets key-value store (KVS) requirement information such as information on the redundancy of the KVS and the hardware processing of the KVS, based on a decision made by a service user. The data storage destination DB decision unit 26 decides whether to place the access target data of a database in the RDB 5 or KVS 6 based on the data structure information acquired from the data structure storage unit 30, the DB access pattern 41 (described later) acquired from the DB access pattern accumulation unit 31, the KVS requirement information set by the KVS requirement setting unit 25, and the like. The data storage destination DB decision unit 26 stores in the migration content storage unit 32 the contents of a destination location of the decided access target data as data destination location information.

When a difference between read access and write access over a specific time period is equal to or more than a specified time period, the DB migration schedule decision unit 27 decides a timing of the migration of the access target data of the database, and stores the timing as migration schedule information in the migration content storage unit 32. When being notified by the contract change support apparatus 7 that the operation form is changed, the DB migration command unit 28 transmits a database migration command to the DB migration unit 29 in compliance with the migration schedule information. The DB migration unit 29 migrates the access target data of the database in compliance with the database migration command of the DB migration command unit 28, and stores an update request during migration of the access target data in the data temporary storage upon migration unit 33.

### ==Entire Flow==

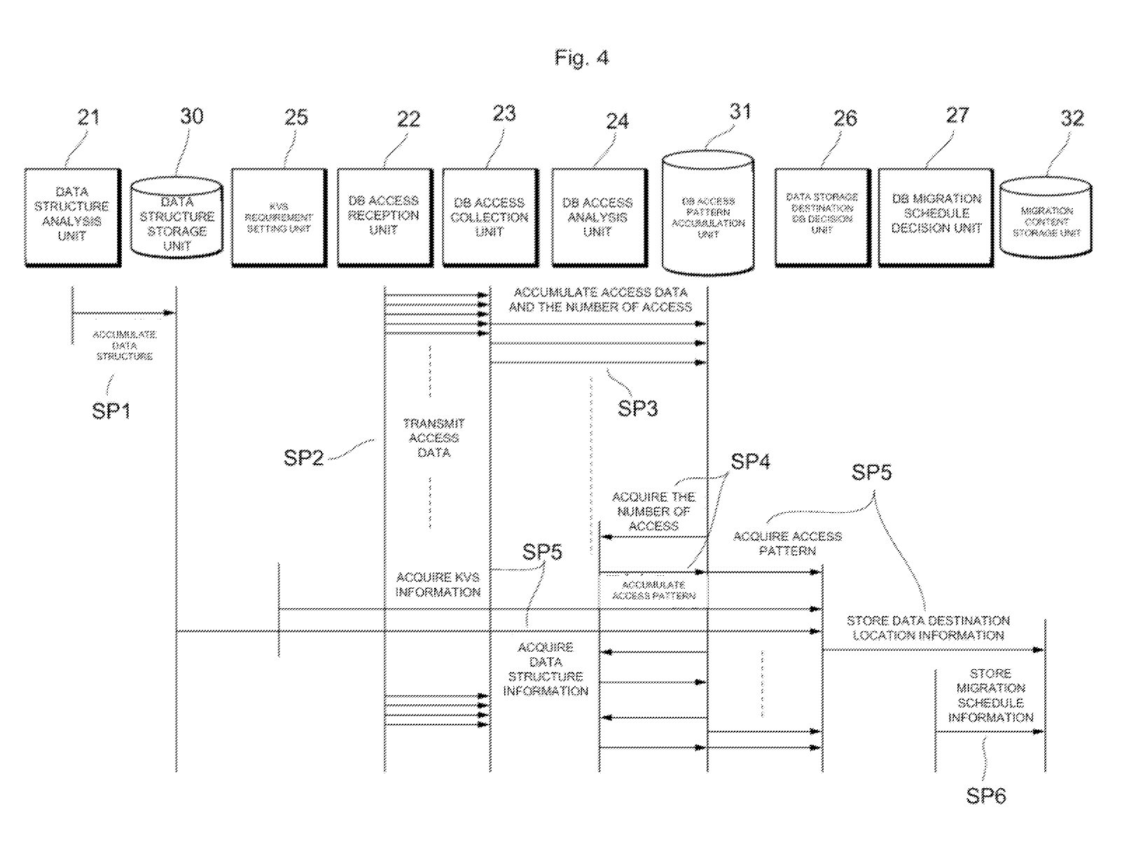

Next, a detailed description will be given of operations of the DB migration management apparatus 4 of the embodiment. FIG. 4 is a flowchart showing the entire flow of the DB migration management apparatus 4 of the embodiment.

In the embodiment, it is assumed to use the DB migration management apparatus 4 when a business form that charges depending on a type of hardware, usage time, and an amount of accumulated data is adopted at a data center where a plurality of databases of two types (the RDB 5 and the KVS 6) is prepared. Furthermore, a data acquisition period m specified in advance by a service user is set to be equal to or more than three times a period during which a pattern is estimated to appear. Moreover, the time necessary to complete data updates, which is dependent on the redundancy of the KVS 6 decided in advance by a service user, is set to be t seconds.

The data structure analysis unit 21 analyzes a cloud business application program received from the application acquisition apparatus 3, and stores data structure information such as information on relations between data, which is the analysis result, in the data structure storage unit 30 (Step SP1).

Next, the DB access reception unit 22 receives write access and read access to access target data from the cloud business application server 2, and transmits to the DB access collection unit 23 write access and read access related to the data structure information stored in the data structure storage unit 30 (Step SP2).

Next, the DB access collection unit 23 groups and counts the write access and read access received from the DB access reception unit 22, and accumulates in the access pattern accumulation unit 31 the grouped and counted numbers of access as well as the write access and read access (Step SP3).

Next, the DB access analysis unit 24 acquires the numbers of access from the access pattern accumulation unit 31, arranges the numbers of access at specified time intervals on the time series, and graphs them. The DB access analysis unit 24 then creates the DB access pattern 41 (described later) to accumulate the pattern in the DB access pattern accumulation unit 31. (Step SP4).

Next, the data storage destination DB decision unit 26 acquires the data structure information, the DB access pattern 41 (described later), the KVS requirement information, and the like to decide whether to place the access target data of a database in the RDB 5 or KVS 6 (Step SP5).

Next, when a difference between read access and write access over a specific time period is equal to or more than a specified amount, the DB migration schedule decision unit 27 decides a timing of the migration of the access target data of the database, and stores the timing as the migration schedule information in the migration content storage unit 32 (Step SP6).

### ==Data Structure Analysis Processing==

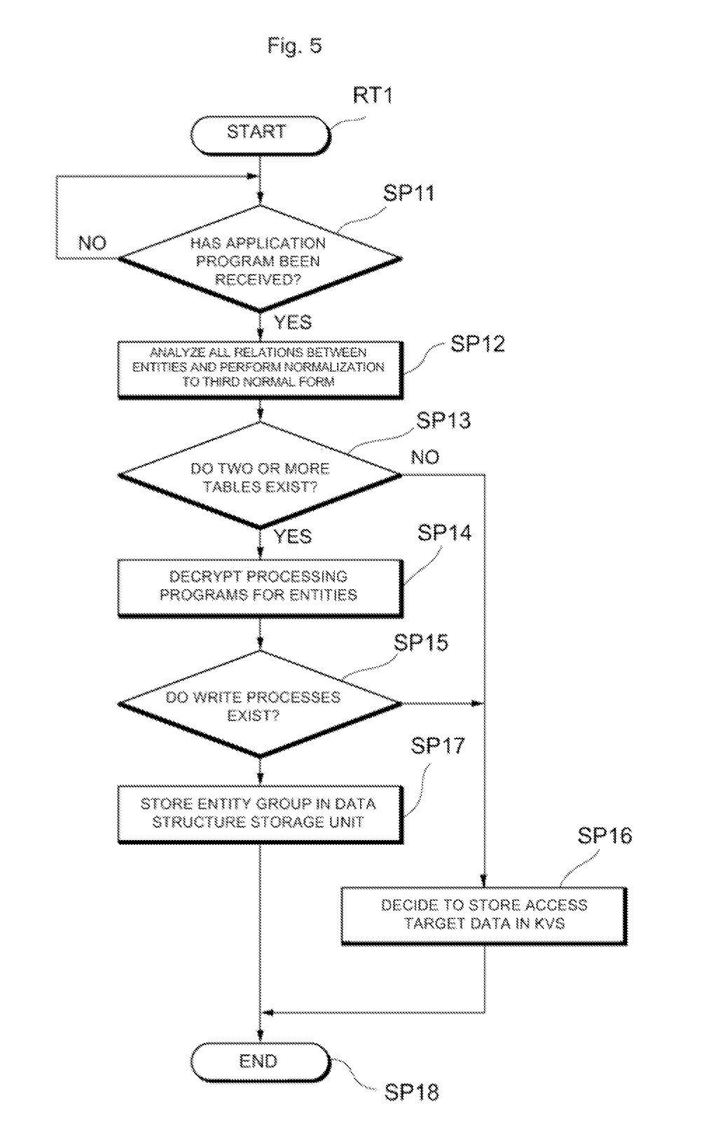

FIG. 5 is a flowchart showing data structure analysis processing of the DB migration management apparatus 4 of the embodiment.

When the DB migration management apparatus 4 is switched on, the data structure analysis unit 21 starts a data structure analysis processing procedure RT1 shown in FIG. 5, and waits in standby mode until receiving a cloud business application program from the application acquisition apparatus 3 (Step SP11).

When receiving the cloud business application program from the application acquisition apparatus 3 after a while (Step SP11: YES), the data structure analysis unit 21 analyzes all relations between entities being specified data units in the received cloud business application program, and performs normalization to the third normal form (Step SP12). Incidentally, a collection of related entities will hereinafter be referred to as the entity group (data structure information).

Next, the data structure analysis unit 21 checks whether or not there exist two or more tables in the entity group normalized to the third normal form (Step SP13).

When there do not exist two or more tables in the entity group (Step Sp13: NO), in other words, when there exists only one table in the entity group, the data structure analysis unit 21 then decides to store the access target data of the entity group in the KVS 6 (Step SP16), and afterwards ends the data structure analysis processing procedure RT1 shown in FIG. 5 (Step SP18).

On the other hands, when there exist two or more tables in the entity group (Step SP13: YES), the data structure analysis unit 21 decrypts processing programs for the entities in the entity group (Step SP14).

Next, the data structure analysis unit 21 checks whether or not there exist write processes in the entities in the entity group (Step SP15). When there do not exist write processes in the entities in the entity group (Step SP15: NO), the data structure analysis unit 21 then decides to store the access target data of the entity group in the KVS 6 (Step SP16), and afterwards ends the data structure analysis processing procedure RT1 shown in FIG. 5 (Step SP18).

On the other hand, when there exist write processes in the entities in the entity group (Step SP15: YES), the data structure analysis unit 21 stores the entity group in the data structure storage unit 30 (Step SP17), and afterwards ends the data structure analysis processing procedure RT1 shown in FIG. 5 (Step SP18).

### ==Access Analysis Processing==

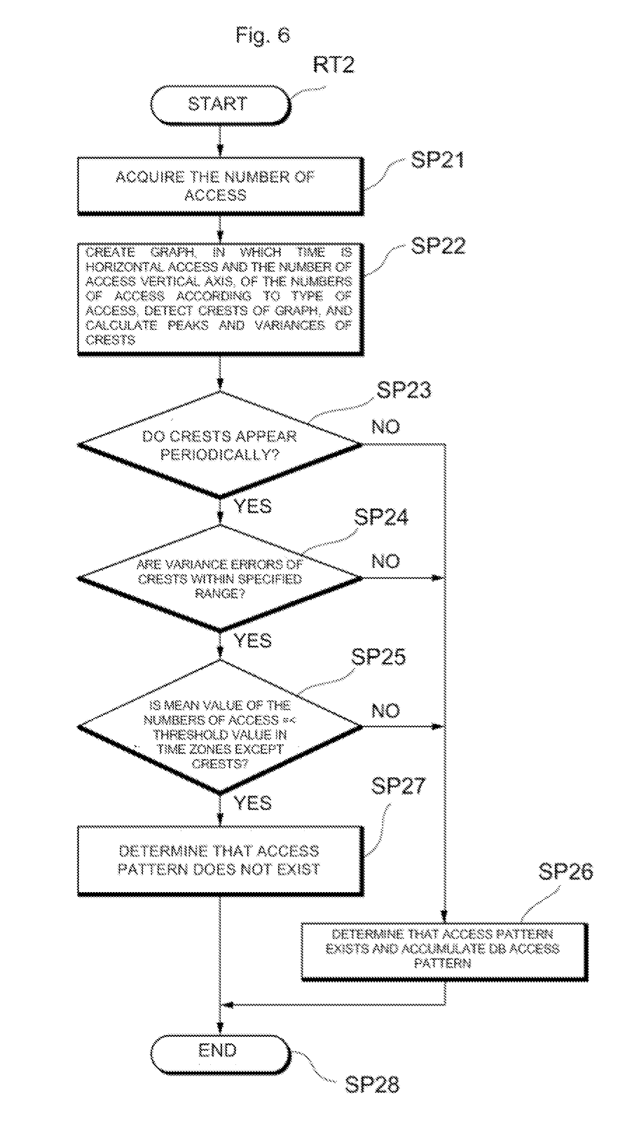

FIG. 6 is a flowchart showing access analysis processing of the DB migration management apparatus 4 of the embodiment.

After a specified time (two-third of the data acquisition period m, for example) passes since the start of receiving the write access and read access related to the entity group stored in the data structure storage unit 30, the DB access analysis unit 24 starts an access analysis processing procedure RT2 shown in FIG. 6, and acquires the numbers of access to the entities in the entity group on a per-second basis from the DB access pattern accumulation unit 31 (Step SP21).

Next, the DB access analysis unit 24 creates a graph of the numbers of access to the entities in the entity group, in which time is the horizontal axis and the number of access is the vertical axis, for each type of access. The DB access analysis unit 24 then detects the crests of the graph and calculates the peak (extreme value) and variance of each crest (Step SP22).

Next, the DB access analysis unit 24 checks whether or not points where the peaks of the crests of the graph appear are related to times, days, days of week, months, holidays, and the like. In other words, the DB access analysis unit 24 checks whether or not the crests of the graph appear periodically at specified times, days, days of week, months, and the like (Step SP23). When the crests of the graph do not appear periodically (Step SP23: NO), the DB access analysis unit 24 determines that an access pattern does not exist (Step SP27), and afterwards ends the access analysis processing procedure RT2 shown in FIG. 6 (Step SP28).

When the crests of the graph appear periodically (Step SP23: YES), the DB access analysis unit 24 checks whether or not variance errors of the crests of the graph are within a specified range (10%, for example) (Step SP24). When the variance errors of the crests of the graph are not within a specified range (Step SP24: NO), the DB access analysis unit 24 then determines that an access pattern does not exist (Step SP27), and afterwards ends the access analysis processing procedure RT2 shown in FIG. 6 (Step SP28).

On the other hand, when the variance errors of the crests of the graph are within a specified range (Step SP24: YES), the DB access analysis unit 24 checks whether or not the mean value of the numbers of access is equal to or less than a specified threshold value in time zones except the crests of the graph (Step SP25). When the mean value of the numbers of access is not equal to or less than the specified threshold value in the time zones except the crests of the graph (Step SP25: NO), the DB access analysis unit 24 then determines that an access pattern does not exist (Step SP27), and afterwards ends the access analysis processing procedure RT2 shown in FIG. 6 (Step SP28).

On the other hand, when the mean value of the numbers of access is equal to or less than the specified threshold value (described later) in the time zones except the crests of the graph (Step SP25: NO), the DB access analysis unit 24 determines that an access pattern exists, accumulates the graph in the DB access pattern accumulation unit 31 as the DB access pattern 41 (described later) (Step SP26), and afterwards ends the access analysis processing procedure RT2 shown in FIG. 6 (Step SP28).

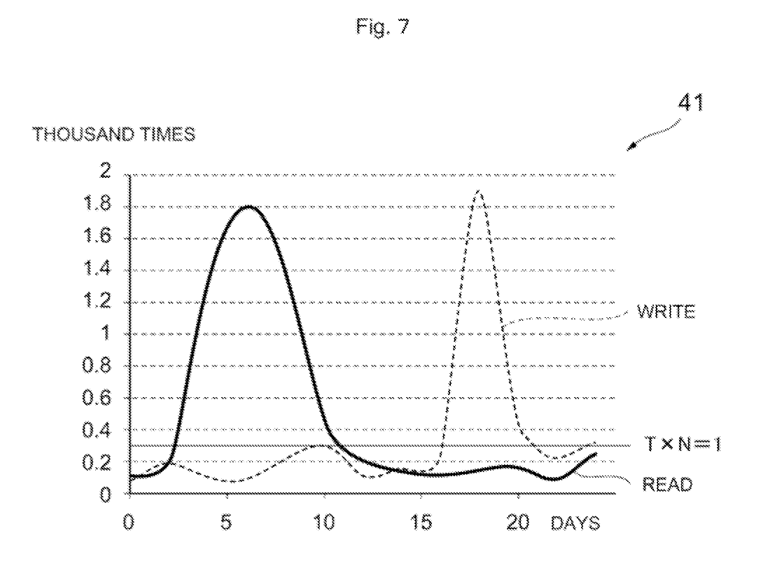

FIG. 7 is a view showing an example of the DB access pattern 41. Time is the horizontal axis of the DB access pattern 41 and the number of access the vertical axis thereof.

When a day's worth of access to the entity group accumulates in the DB access pattern accumulation unit 31, for example, the DB access analysis unit 24 acquires the number of a day's worth of access to the entity group from the DB access pattern accumulation unit 31, and starts access pattern analysis on a per-hour basis.

Additionally, when a week's worth of access to the entity group accumulates in the DB access pattern accumulation unit 31, for example, the DB access analysis unit 24 acquires the number of a week's worth of access to the entity group from the DB access pattern accumulation unit 31, and starts access pattern analysis on a per-day basis.

Moreover, when a month's worth of access to the entity group accumulates in the DB access pattern accumulation unit 31, for example, the DB access analysis unit 24 acquires the number of a month's worth of access to the entity group from the DB access pattern accumulation unit 31, and starts access pattern analysis on a per day of week basis.

Furthermore, when three months' worth of access to the entity group accumulates in the DB access pattern accumulation unit 31, for example, the DB access analysis unit 24 acquires the number of three months' worth of access to the entity group from the DB access pattern accumulation unit 31, and starts access pattern analysis on a per-month basis and access pattern analysis for a specified time period.

### ==Storage Destination Decision Processing==

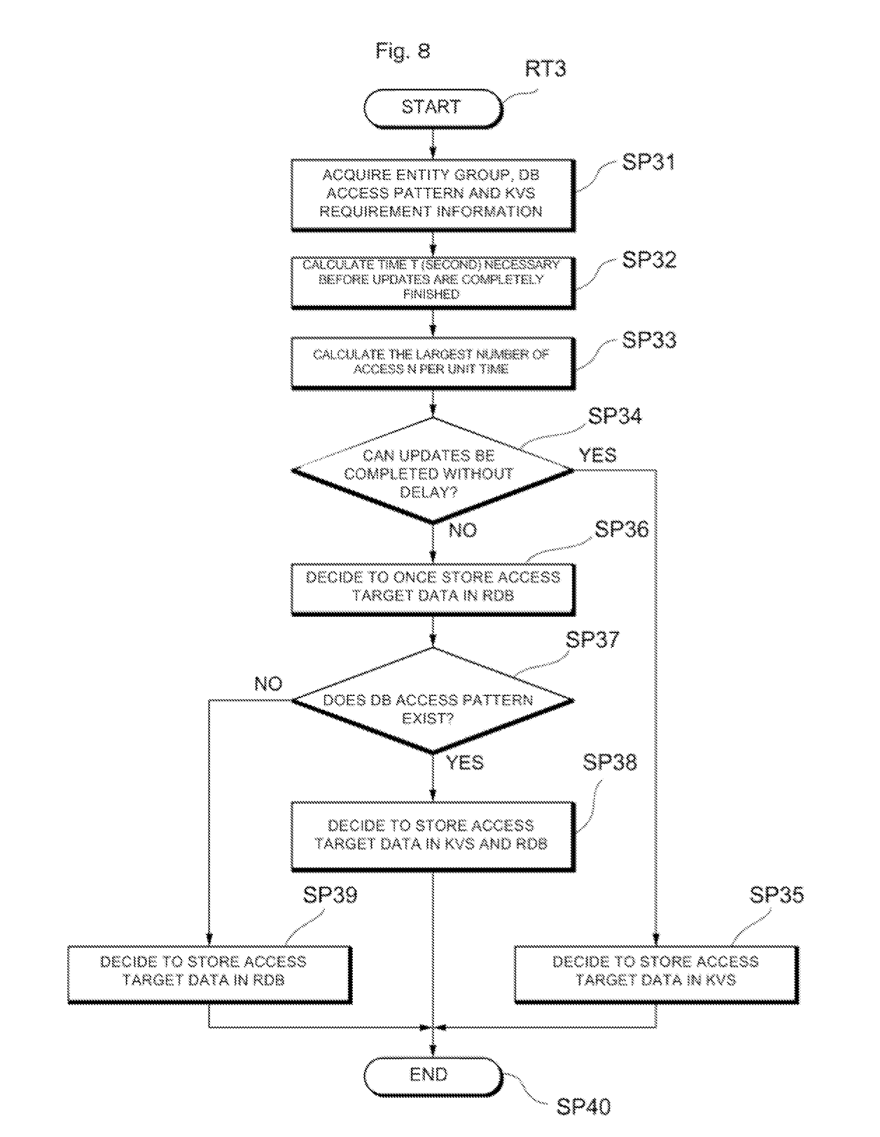

FIG. 8 is a flowchart showing storage destination decision processing of the DB migration management apparatus 4 of the embodiment.

After a specified time (two-third of the data acquisition period m, for example) passes since the start of receiving the write access and read access related to the entity group stored in the data structure storage unit 30, the data storage destination DB decision unit 26 starts a data storage destination decision processing procedure RT3 shown in FIG. 8, and acquires the entity group stored in the data structure storage unit 30, the numbers of access to the entities in the entity group accumulated in the DB access pattern accumulation unit 31, and the KVS requirement information from the KVS requirement setting unit 25 (Step SP31).

Next, the data storage destination DB decision unit 26 calculates the number of entities that are influenced when one entity is changed among the relations of the acquired entity group, and further when an updating process is performed on an entity having the most relations with the other entities in the KVS requirement information, the data storage destination DB decision unit 26 calculates the time T (second) necessary to update all the related entities in the entity group in the KVS 6 (Step SP32).

Next, the data storage destination DB decision unit 26 calculates the largest number of access N per unit time among the numbers of access to the same entity in the acquired entity group (Step SP33).

Next, the data storage destination DB decision unit 26 checks whether or not it is possible to complete all updates of the related entities in the acquired entity group without delay (Step SP34). When it is possible to complete all updates of the related entities in the acquired entity group without delay (Step SP34: YES), the data storage destination DB decision unit 26 then decides to store the access target data of the entity group in the KVS 6 (Step SP35).

Specifically, when a value obtained by multiplying the time T (second) necessary to update all the related entities in the acquired entity group by the largest number of access N to the acquired entity group per unit time is less than one, the data storage destination DB decision unit 26 determines that it is possible to complete all updates of the related entities in the entity group without delay (T·N<1). In addition, the data storage destination DB decision unit 26 stops the DB access collection unit 23 from accumulating all the write access and read access to the related entities in the acquired entity group.

On the other hand, when it is not possible to complete all updates of the related entities in the entity group without delay (Step SP34: NO), in other words, when a delay occurs in the updates of the entities in the acquired entity group, the data storage destination DB decision unit 26 decides to once store the access target data of the entity group in the RDB 5 (Step SP36).

Next, the data storage destination DB decision unit 26 checks whether or not the DB access pattern 41 of the acquired entity group exists in the DB access pattern accumulation unit 31 (Step SP37). When the DB access pattern 41 of the acquired entity group exists in the DB access pattern accumulation unit 31 (Step SP37: YES), the data storage destination DB decision unit 26 decides to store the access target data of the acquired entity group in the RDB 5 and the KVS 6 (Step SP38), and afterwards ends the data storage destination decision processing procedure RT3 shown in FIG. 8 (Step SP40).

On the other hand, when the DB access pattern 41 of the acquired entity group does not exist in the DB access pattern accumulation unit 31 (Step SP37: NO), the data storage destination DB decision unit 26 decides to store the access target data of the acquired entity group in the RDB 5 (Step SP39), and afterwards ends the data storage destination decision processing procedure RT3 shown in FIG. 8 (Step SP40).

When the data storage destination DB decision unit 26 decides to store the access target data of the acquired entity group in the RDB 5 and the KVS 6, the DB migration schedule decision unit 27 distinguishes a period during which the number of write access is large, and decides migration schedule information in a manner that the migration to the RDB 5 of the access target data of the entity group is completed immediately before a period corresponding to the distinguished period, as well as distinguishes a period during which the number of read access is large, and decides migration schedule information in a manner that the migration to the KVS 6 of the access target data of the entity group is completed immediately before a period corresponding to the distinguished period.

### ==Database Migration Processing==

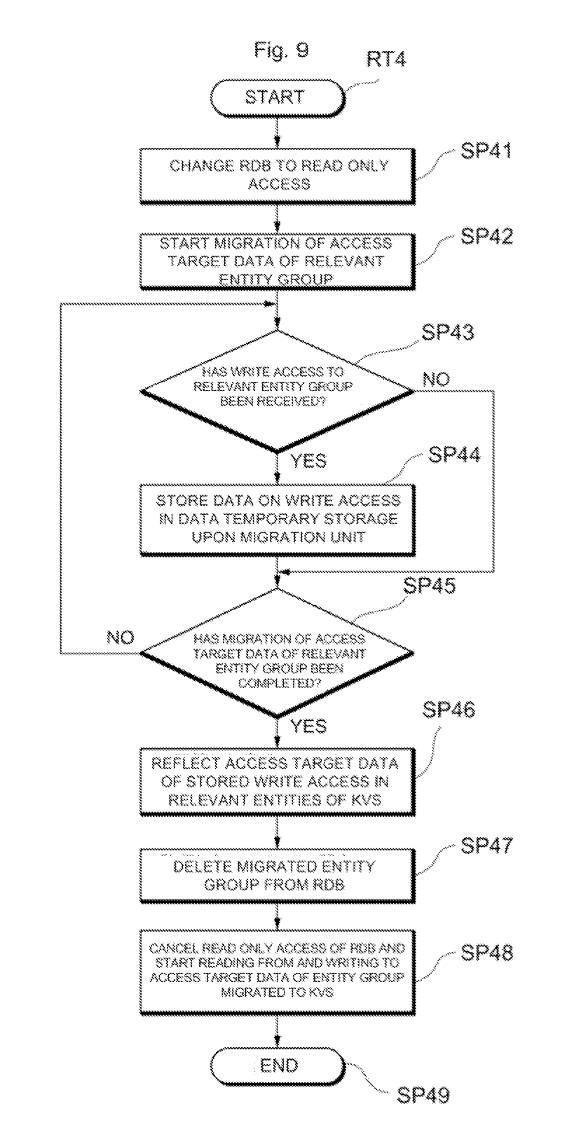

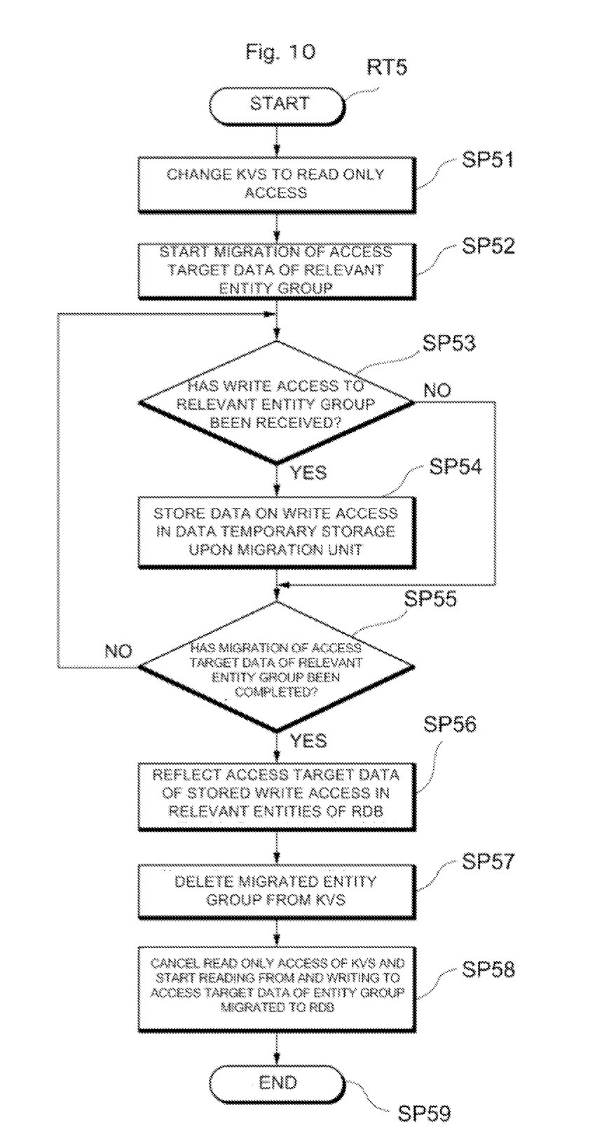

FIGS. 9 and 10 are flowcharts showing database migration processing of the DB migration management apparatus 4 of the embodiment.

In the contract change support apparatus 7, billing information related to use of a database at a data center is preset. The contract change support apparatus 7 can calculate a yearly database usage charge amount by checking the result of the migration schedule information. In addition, the contract change support apparatus 7 can transmit to a user of a cloud business application service the result of the yearly database usage charge amount. When a user of a cloud business application service accepts a database migration type of operations, the contract change support apparatus 7 changes the contents of the contract.

The DB migration management apparatus 4 switches on a database migration function of the DB migration schedule decision unit 27, and the DB migration command unit 28, too, following the change of the contents of the contract. The DB migration command unit 28 compares the migration schedule information of the DB migration schedule decision unit 27 with the current date and time, and transmits a database migration command to the DB migration unit 29 at the time of starting the migration of access target data.

When the database migration command is a database migration command from the RDB 5 to the KVS6, the DB migration unit 29 starts a database migration processing procedure RT4 shown in FIG. 9, and changes the RDB 5 to read only access (Step SP41). Next, the DB migration unit 29 starts the migration of the access target data of a relevant entity group (Step SP42).

Next, the DB migration unit 29 acquires information on write access to the relevant entity group from the DB access reception unit 22, and checks whether to have received the write access to the relevant entity group (Step SP43). When having not received the write access to the relevant entity group (Step SP43: NO), the DB migration unit 29 proceeds to Step SP45.

On the other hand, when having received the write access to the relevant entity group (Step SP43: YES), the DB migration unit 29 stores the access target data of the write access to the relevant entity group in the data temporary storage upon migration unit 33 (Step SP44).

Next, the DB migration unit 29 checks whether to have completed the migration of the access target data of the relevant entity group (Step SP45). When having not completed the migration of the access target data of the relevant entity group (Step SP45: NO), the DB migration unit 29 then returns to Step SP43, and rechecks whether to have received the write access to the relevant entity group.

On the other hand, when having completed the migration of the access target data of the relevant entity group (Step SP45: YES), the DB migration unit 29 reflects the access target data of the write access stored in the data temporary storage upon migration unit 33 in the relevant entity group of the KVS 6 (Step SP46).

Next, the DB migration unit 29 deletes the migrated entity group from the RDB 5 (Step SP47). Next, the DB migration unit 29 cancels read only access of the RDB 5, and starts reading from and writing to the access target data of the entity group migrated to the KVS 6 (Step SP48). The DB migration unit 29 ends the database migration processing procedure RT4 shown in FIG. 9 afterwards (Step SP49).

Meanwhile, when the database migration command is a database migration command from the KVS6 to the RDB 5, the DB migration unit 29 starts a database migration processing procedure RT5 shown in FIG. 10, and changes the KVS 6 to read only access (Step SP51). The DB migration unit 29 starts the migration of the access target data of a relevant entity group (Step SP52).

Next, the DB migration unit 29 acquires information on write access to the relevant entity group from the DB access reception unit 22, and checks whether to have received the write access to the relevant entity group (Step SP53). When having not received the write access to the relevant entity group (Step SP 53: NO), the DB migration unit 29 then proceeds to Step SP55.

On the other hand, when having received the write access to the relevant entity group (Step SP53: YES), the DB migration unit 29 stores the access target data of the write access to the relevant entity group in the data temporary storage upon migration unit 33 (Step SP54).

Next, the DB migration unit 29 checks whether to have completed the migration of the access target data of the relevant entity group (Step SP55). When having not completed the migration of the access target data of the relevant entity group (Step SP55: NO), the DB migration unit 29 then returns to Step SP53, and rechecks whether to have received the write access to the relevant entity group.

On the other hand, when having completed the migration of the access target data of the relevant entity group (Step SP55: YES), the DB migration unit 29 reflects the access target data of the write access stored in the data temporary storage upon migration unit 33 in the relevant entity group of the RDB 5 (Step SP56).

Next, the DB migration unit 29 deletes the migrated entity group from the KVS 6 (Step SP57). Next, the DB migration unit 29 cancels read only access of the KVS 6, and starts reading from and writing to the access target data of the entity group migrated to the RDB 5 (Step SP58). The DB migration unit 29 ends the database migration processing procedure RT5 shown in FIG. 10 afterwards (Step SP59).

In this manner, upon migration of access target data, the DB migration unit 29 causes a database of a migration source to be referred to for read access while causing the access target data of write access to be stored in the data temporary storage upon migration unit 33 and be reflected all together after the completion of the migration. Incidentally, with regard to the migration processing, used is an existing technology such as backing up and restoring.

n this manner, in the DB migration management apparatus 4, when a delay occurs in updates of entities of an acquired entity group, and the DB access pattern 41 of the acquired entity group exists, the data storage destination DB decision unit 26 decides to store the access target data of the acquired entity group in the RDB 5 and the KVS 6, and when the data storage destination DB decision unit 26 decides to store the access target data of the acquired entity group in the RDB 5 and the KVS 6, the DB migration schedule decision unit 27 distinguishes a period during which the number of write access is large, and decides migration schedule information in a manner that the migration to the RDB 5 of the access target data of the entity group is completed immediately before a period corresponding to the distinguished period, as well as distinguishes a period during which the number of read access is large, and decides migration schedule information in a manner that the migration to the KVS 6 of the access target data of the entity group is completed immediately before a period corresponding to the distinguished period.

Accordingly, it is possible to realize inexpensive and highly scalable operations, while realizing sturdy processing, of not only an application whose data structure is simple but also an application necessary to maintain integrity for a system that can pattern operation timing.

Moreover, it is possible for providers and users to reduce operating costs and usage costs, respectively, by causing not only high-performance and expensive hardware but also inexpensive hardware to coexist.

Furthermore, it is possible to free expensive hardware resource temporarily based on a result of analyzing a user's database access pattern. Therefore, it is possible to place access target data in a manner that different services whose access times are different use the same database, and to realize an improvement in use efficiency of expensive hardware. Additionally, it is possible to keep access target data placed in the RDB 5 having low scalability to minimum necessity. Therefore, it is possible to facilitate the migration of access target data, the backing up of access target data, and the implementation of the maintenance of hardware when troubles occur.

Note that the present embodiment can be applied also in cases of a configuration in which a relational database is made redundant and scaling out a key-value store to a plurality of servers.

Moreover, other than the key-value store, the present embodiment can be applied to a database that has different properties from those of a relational database and has characteristics that performance on write access is inferior to that of a relational database; however, performance on read access is superior to that of a relational database.

Furthermore, since data access patterns of systems are accumulated in the database access pattern accumulation unit 31, the present embodiment can promote an improvement in operational efficiency of a database by causing an entire data center to manage the database access patterns and spreading times when a load is applied.

A part or a whole of the above embodiment may be described as in the following supplementary notes, but is not limited to the following.

(Supplementary Note 1) A database migration management apparatus including: an access collection unit configured to collect write access and read access transmitted from a specified server, and store the numbers of access to a first database having low scalability and a second database having high scalability for each piece of information on access target data and each type of access in a storage unit at specified time intervals; an access analysis unit configured to determine whether there exists a specified pattern in the numbers of access at the specified time intervals collected by the access collection unit, and store the numbers of access at the specified time intervals in the storage unit as an access pattern when there exists the pattern; a data storage destination decision unit configured to decide to place the access target data in the first database and the second database when there exists the access pattern analyzed by the access analysis unit; and a migration schedule decision unit configured to, when the data storage destination decision unit places the access target data in the first database and the second database: distinguish a period during which the number of the write access is equal to or more than a specified number to decide a migration schedule such that the access target data obtained over a period corresponding to the distinguished period is placed in the first database; and distinguish a period during which the number of the read access is equal to or more than a specified number to decide a migration schedule such that the access target data obtained over a period corresponding to the distinguished period is placed in the second database.

(Supplementary Note 2) The database migration management apparatus according to Supplementary Note 1, further including a data structure analysis unit configured to analyze relations of entities being specified data units of an application program to be executed by the server, and store information on an entity group being a collection of related entities in the storage unit, wherein the data storage destination decision unit is configured to, when a delay occurs in all updates of related entities in the entity group in a case where a part of the entity group is updated, and when the access pattern exists, decide to place the access target data in the first database and the second database, and the migration schedule decision unit is configured to, when the data storage destination decision unit places the access target data in the first database and the second database: distinguish a period during which the number of the write access is equal to or more than a specified number to decide a migration schedule such that the access target data obtained over a period corresponding to the distinguished period is placed in the first database; and distinguish a period during which the number of the read access is equal to or more than a specified number to decide a migration schedule such that the access target data obtained over a period corresponding to the distinguished period is placed in the second database.

(Supplementary Note 3) The database migration management apparatus according to Supplementary Note 2, wherein the data structure analysis unit is configured to normalize the entity group to a third normal form, decrypt processing programs for the entities in the entity group when there exist two or more tables in the entity group normalized to the third normal form, and store information on the entity group when there exists write processes in the entities in the entity group, and the data storage destination decision unit is configured to decide to place relevant access target data in the second database when the information on the entity group is not stored.

(Supplementary Note 4) The database migration management apparatus according to Supplementary Note 2, wherein the data storage destination decision unit is configured to decide to place relevant access target data in the second database, when all the updates of the related entities in the entity group is completed without delay in a case where a part of the entity group is updated.

(Supplementary Note 5) The database migration management apparatus according to Supplementary Note 1, wherein the access analysis unit is configured to: graph the numbers of access at the specified time intervals to detect extreme values of the graph; and calculate extreme values and variances around the extreme values to store the access pattern when the related extreme values appear at any one of specified times, specified days, specified days of week, and specified months, and variance errors around the extreme values are within a specified range, and a mean value of the numbers of access at the specified time intervals is equal to or less than a specified threshold value during time zones except around the extreme values.

(Supplementary Note 6) The database migration management apparatus according to Supplementary Note 2, wherein the data storage destination decision unit is configured to, when a delay occurs in all the updates of the related entities in the entity group in a case where a part of the entity group is updated, and when the access pattern does not exist, decide to place relevant access target data in the first database.

(Supplementary Note 7) The database migration management apparatus according to Supplementary Note 2, wherein the data storage destination decision unit is configured to: acquire information on hardware processing and redundancy of the first database, which are decided by a user; calculate time necessary to update all the related entities in the entity group, as well as calculates the largest number of access per unit time among the numbers of access to the same entity in the entity group, based on the number of the entities that are influenced when a part of the entity group is updated, and the information on the hardware processing and the redundancy of the first database; and decide to place the access target data in the first database and the second database when a value obtained by multiplying the time necessary to update all the related entities in the entity group by the largest number of access is equal to or more than one, and the access pattern exists, and wherein the migration schedule decision unit is configured to: when the data storage destination decision unit places the access target data in the first database and the second database, distinguish a period during which the number of the write access is equal to or more than a specified number to decide a migration schedule such that the access target data obtained over a period corresponding to the distinguished period is placed in the first database; and distinguish a period during which the number of the read access is equal to or more than a specified number to decide a migration schedule such that the access target data obtained over a period corresponding to the distinguished period is placed in the second database.

(Supplementary Note 8) A database migration management method including: a first step of causing an access collection unit to collect write access and read access transmitted from a specified server, and store the numbers of access to a first database having low scalability and a second database having high scalability for each piece of information on access target data and each type of access in a storage unit at specified time intervals; a second step of causing an access analysis unit to determine whether there exists a specified pattern in the numbers of access at the specified time intervals collected in the first step, and store the numbers of access at the specified time intervals in the storage unit as an access pattern when there exists the pattern; a third step of causing a data storage destination decision unit to decide to place the access target data in the first database and the second database when there exists the access pattern analyzed in the second step; and a fourth step of, when the access target data is placed in the first database and the second database in the third step, causing a migration schedule decision unit to: distinguish a period during which the number of the write access is equal to or more than a specified number to decide a migration schedule such that the access target data obtained over a period corresponding to the distinguished period is placed in the first database; and distinguish a period during which the number of the read access is equal to or more than a specified number to decide a migration schedule such that the access target data obtained over a period corresponding to the distinguished period is placed in the second database.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

I (we) claim:

1. A database migration management apparatus comprising:
an access collection unit configured to collect write access and read access transmitted from a specified server, and store the numbers of access to a first database having low scalability and a second database having high scalability for each piece of information on access target data and each type of access in a storage unit at specified time intervals;
an access analysis unit configured to determine whether there exists a specified pattern in the numbers of access at the specified time intervals collected by the access collection unit, and store the numbers of access at the specified time intervals in the storage unit as an access pattern when there exists the pattern;
a data storage destination decision unit configured to decide to place the access target data in the first database and the second database when there exists the access pattern analyzed by the access analysis unit; and
a migration schedule decision unit configured to, when the data storage destination decision unit places the access target data in the first database and the second database:
distinguish a period during which the number of the write access is equal to or more than a specified number to decide a migration schedule such that the access target data obtained over a period corresponding to the distinguished period is placed in the first database; and
distinguish a period during which the number of the read access is equal to or more than a specified number to decide a migration schedule such that the access target data obtained over a period corresponding to the distinguished period is placed in the second database.

2. The database migration management apparatus according to claim 1, further comprising a data structure analysis unit configured to analyze relations of entities being specified data units of an application program to be executed by the server, and store information on an entity group being a collection of related entities in the storage unit, wherein
the data storage destination decision unit is configured to, when a delay occurs in all updates of related entities in the entity group in a case where a part of the entity group is updated, and when the access pattern exists, decide to place the access target data in the first database and the second database, and
the migration schedule decision unit is configured to, when the data storage destination decision unit places the access target data in the first database and the second database:
distinguish a period during which the number of the write access is equal to or more than a specified number to decide a migration schedule such that the access target data obtained over a period corresponding to the distinguished period is placed in the first database; and
distinguish a period during which the number of the read access is equal to or more than a specified number to decide a migration schedule such that the access target data obtained over a period corresponding to the distinguished period is placed in the second database.

3. The database migration management apparatus according to claim 2, wherein
the data structure analysis unit is configured to normalize the entity group to a third normal form, decrypt processing programs for the entities in the entity group when there exist two or more tables in the entity group normalized to the third normal form, and store information on the entity group when there exists write processes in the entities in the entity group, and
the data storage destination decision unit is configured to decide to place relevant access target data in the second database when the information on the entity group is not stored.

4. The database migration management apparatus according to claim 2, wherein the data storage destination decision unit is configured to decide to place relevant access target data in the second database, when all the updates of the related entities in the entity group is completed without delay in a case where a part of the entity group is updated.

5. The database migration management apparatus according to claim 1, wherein the access analysis unit is configured to:
graph the numbers of access at the specified time intervals to detect extreme values of the graph; and
calculate extreme values and variances around the extreme values to store the access pattern when the related extreme values appear at any one of specified times, specified days, specified days of week, and specified months, and variance errors around the extreme values are within a specified range, and a mean value of the numbers of access at the specified time intervals is equal to or less than a specified threshold value during time zones except around the extreme values.

6. The database migration management apparatus according to claim 2, wherein the data storage destination decision unit is configured to, when a delay occurs in all the updates of the related entities in the entity group in a case where a part of the entity group is updated, and when the access pattern does not exist, decide to place relevant access target data in the first database.

7. The database migration management apparatus according to claim 2, wherein
the data storage destination decision unit is configured to:
acquire information on hardware processing and redundancy of the first database, which are decided by a user;
calculate time necessary to update all the related entities in the entity group, as well as calculates the largest number of access per unit time among the numbers of access to the same entity in the entity group, based on the number of the entities that are influenced when a part of the entity group is updated, and the information on the hardware processing and the redundancy of the first database; and
decide to place the access target data in the first database and the second database when a value obtained by multiplying the time necessary to update all the related entities in the entity group by the largest number of access is equal to or more than one, and the access pattern exists, and wherein
the migration schedule decision unit is configured to:
when the data storage destination decision unit places the access target data in the first database and the second database, distinguish a period during which the number of the write access is equal to or more than a specified number to decide a migration schedule such that the access target data obtained over a period corresponding to the distinguished period is placed in the first database; and
distinguish a period during which the number of the read access is equal to or more than a specified number to decide a migration schedule such that the access target data obtained over a period corresponding to the distinguished period is placed in the second database.

8. A database migration management method comprising:
a first step of causing an access collection unit to collect write access and read access transmitted from a specified server, and store the numbers of access to a first database having low scalability and a second database having high scalability for each piece of information on access target data and each type of access in a storage unit at specified time intervals;
a second step of causing an access analysis unit to determine whether there exists a specified pattern in the numbers of access at the specified time intervals collected in the first step, and store the numbers of access at the specified time intervals in the storage unit as an access pattern when there exists the pattern;
a third step of causing a data storage destination decision unit to decide to place the access target data in the first database and the second database when there exists the access pattern analyzed in the second step; and
a fourth step of, when the access target data is placed in the first database and the second database in the third step, causing a migration schedule decision unit to:
distinguish a period during which the number of the write access is equal to or more than a specified number to decide a migration schedule such that the access target data obtained over a period corresponding to the distinguished period is placed in the first database; and
distinguish a period during which the number of the read access is equal to or more than a specified number to decide a migration schedule such that the access target data obtained over a period corresponding to the distinguished period is placed in the second database.
